(19) United States
(12) Patent Application Publication
(10) Pub. No.: US 2009/0278768 A1
(43) Pub. Date: Nov. 12, 2009

(54) Method and apparatus for processing video data for display on a plasma display panel

(76) Inventors: Seung-Ho Park, Suwon-si (KR); Young-Sun Kim, Suwon-si (KR); Yu-Hoon Kim, Suwon-si (KR); Choon-Woo Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/453,277

(22) Filed: May 5, 2009

(30) Foreign Application Priority Data
May 6, 2008 (KR) 10-2008-0041932

(51) Int. Cl. G09G 3/28

(52) U.S. Cl. 345/63

(57) ABSTRACT

A method and an apparatus for processing video data for display on a plasma display panel include dividing gray level values reverse gamma corrected with respect to input gray level values into an integer portion, an upper decimal fraction portion and a lower decimal fraction portion. The lower decimal fraction is then dithered, a first update value generated according to the lower decimal fraction dithering result is added to the upper decimal fraction portion, and the upper decimal fraction having the first update value added thereto is dithered. Finally, a second update value generated according to the upper decimal fraction dithering result is added to the integer portion.

### BACKGROUND OF THE INVENTION

1. Field of the Invention

Embodiments relate to a method and an apparatus for processing video data for display on a plasma display panel. More particularly, embodiments relate to a method and an apparatus for dithering video data for display on a plasma display panel capable of smoothly displaying still and moving images.

2. Description of the Related Art

A plasma display panel (PDP) is a display apparatus that may be connected to various apparatuses, e.g., a personal computer (PC), a video cassette recorder (VCR), a DVD player, a set-top box, an antenna, etc., to receive and reproduce video and audio data. Color video data may include R, G, and B video data represented by 256-step gray levels, e.g., 0 to 255, to indicate brightness.

FIGS. 1A and 1B are graphs comparing brightness characteristics of a general cathode ray tube (CRT) and a PDP, respectively. As shown in FIGS. 1A and 1B, the CRT and the PDP have different brightness characteristics with respect to input gray level values. While the brightness characteristic with respect to the input gray level value of the CRT is non-linear, the brightness characteristic with respect to the input gray level value of the PDP is nearly linear within an operation range. Therefore, in order to equalize an image displayed on the PDP and an image on the CRT, the brightness characteristic of the PDP should be equalized to that of the CRT. Such a process is referred to as ‘reverse gamma correction’.

In the case of performing the reverse gamma correction, a gray level representation problem occurs, especially in a dark region, due to reduction of the number of representable gray levels. That is, a low gray level portion is not faithfully reproduced according to the reduction of the number of the gray levels, so that the number of the gray levels capable of being represented in the dark region are reduced, thereby causing pseudo contour, resulting in a lumped image.

The gray level representation problem due to the reverse gamma correction in the PDP will be described in detail with reference to FIG. 2. FIG. 2 is a graph showing target brightness and a result of the reverse gamma correction with respect to a low gray level region in a PDP. In FIG. 2, a dotted line indicates the target brightness desired to be represented after the reverse gamma correction, a solid line including dots indicates the brightness of the PDP before the reverse gamma correction, and the solid line in a step shape indicates the brightness after the reverse gamma correction.

Referring to FIG. 2, since the PDP outputs only integer values, an input gray level is converted into an integer gray level that represents the brightness in accordance with the R, G, and B input values at the time of the reverse gamma correction and is output as the closest brightness value. Also, the low gray level region of the reverse gamma curve has a lower slope than a high gray level region. Therefore, when performing the reverse gamma correction, a smooth brightness curve targeted near the low gray level is changed into a step shape. As such, in the existing PDP, the number of the gray levels capable of being represented in the low gray level region is reduced, causing still image pseudo contour, which may deteriorate image quality of a still image.

Generally, in order to increase the number of the gray levels capable of being represented in the low gray level region, an error diffusion method or a dithering method, which are gray level reproduction methods, is widely used. Both methods represent the input value as a mean value of a certain region.

The error diffusion method multiplies an error generated by difference between a gray level value determined by the reverse gamma correction and a gray level value really represented on a PDP screen by a predetermined weight to propagate the error to peripheral pixels. However, the error diffusion method requires a large computational quantity and memory, as compared to the dithering method. Therefore, in order to reduce the computational quantity and memory, the dithering method is primarily used.

The dithering method compares a decimal fraction portion of the gray level value determined after the reverse gamma correction with a predetermined threshold value of a dithering mask to assign either 0 or 1 to the decimal fraction portion. In particular, after the reverse gamma correction, the decimal fraction portion is smaller assigned a value of 1 when less than 0.5 and a value of 0 when larger than 0.5. The binarization result is added to an integer portion of the gray level value after the reverse gamma correction.

However, a pattern of the decimal fraction portion is recognized as noise by human eyesight. In the existing gray level reproduction method, when the same gray level values are input per frame, the decimal fraction portions are positioned at the same position per frame, i.e., they overlap. Also, since gray level representations are independently performed by R, G, and B channels, when the same gray level values are input by the channels, overlap of the decimal fraction portions by the channels in a given frame occurs. As such, the overlap of the decimal fraction portion of a pixel value further increases the difference in the brightness between that pixel and the peripheral pixel. A high difference in brightness between the decimal fraction pixel and the peripheral pixel may be recognized the noise.

Meanwhile, in the dithering method, gray level representation may be improved according to the number of bits of a considered decimal fraction portion. That is, as the number of the bits of the considered decimal fraction portion increases, the gray level capable of being represented in the PDP increases. This indicates that smoother low gray level images may be reproduced in the PDP.

However, when the number of bits of the considered decimal fraction portion increases, the existing dithering method increases mask size, making the distance between the decimal fraction portions farther in a dithering result of a lower level, thereby generating isolated noise recognized as bad image quality.

Also, the existing dithering mask has been manufactured in consideration of the isolated noise and the pattern of the decimal fraction pixel in the still image. However, since human eyesight differently recognizes the dithering pattern according to movement and speed of the image, a prescribed pattern that is not noticeable in the still image may appear as noise in a moving image.

### SUMMARY OF THE INVENTION

Embodiments are therefore directed to a method and an apparatus for processing video data for display on a PDP, which overcome one or more of the disadvantages of the related art.

It is a feature of an embodiment to provide a method and an apparatus for processing video data for display on a PDP capable of reducing noises in still and moving images due to dithering.

It is another feature of an embodiment to provide a method and an apparatus for processing video data for display on a PDP capable of reducing noise due to the decimal fraction pixel distance generated using a general dithering method.

It is yet another feature of an embodiment to provide a method and an apparatus for processing video data for display on a PDP capable of displaying a smooth image.

It is still another feature of an embodiment to provide a method and an apparatus for processing video data for display on a PDP capable of reducing or preventing overlap of the decimal fraction pixels between frames and/or between channels.

It is still another feature of an embodiment to provide a method and an apparatus for processing video data for display on a PDP capable of reducing flicker in the dithering considering 4 frames by uniformly distributing the decimal fraction pixels.

It is still another feature of an embodiment to provide a method and an apparatus for processing video data for display on a PDP capable of reducing dithering pattern issues in both still and moving images.

At least one of the above and other features and embodiments may be realized by providing a method for processing video data for display on a plasma display panel using a dithering mask, the method including performing reverse gamma correction with respect to gray level values to input image signals, dividing the reverse gamma corrected gray level values into an integer portion, an upper decimal fraction portion, and a lower decimal fraction portion, dithering the lower decimal fraction, adding a first update value generated according to the lower decimal fraction dithering result to the upper decimal fraction portion, dithering the upper decimal fraction having the first update value added thereto, and adding a second update value generated according to the upper decimal fraction dithering result to the integer portion.

Dithering the lower decimal fraction portion may include updating a temporal random sequence after a prescribed number of frames. Dithering the lower decimal fraction portion may include updating the temporal random sequence only at one or both of a first part and a second part of a frame. The lower decimal fraction portion may be 4 bits, the upper decimal fraction portion may be 3 bits, and dithering the upper decimal fraction portion may use an 8×8 dithering mask.

Dithering the lower decimal fraction portion may include updating a spatial random sequence after a prescribed number of frames. Dithering the lower decimal fraction portion may include simultaneously updating the spatial random sequence and the temporal random sequence. Dithering the lower decimal fraction portion may include generating a mask sequence for each frame by adding a value of the temporal random sequence for that frame to all values of the spatial random sequence.

The input image signals may be R, G, B signals. The method may further include, before adding the second update value, shifting the integer portion.

At least one of the above and other features and embodiments may be realized by providing an apparatus for processing video data for display on a plasma display panel, including a reverse gamma correcting block configured to reverse gamma correct input image signals, and divide and output the reverse gamma corrected values into an integer portion, an upper decimal fraction portion, and a lower decimal fraction portion, a lower decimal fraction portion dithering block configured to output a lower decimal fraction portion update value for the lower decimal fraction portion received from the reverse gamma correcting block, an upper decimal fraction portion dithering block configured to add the lower decimal fraction portion update value received from the lower decimal fraction portion dithering block and to output an upper decimal fraction portion update value for the upper decimal fraction portion received from the reverse gamma correcting block, and an output stage block configured to add the upper decimal fraction portion update value received from the upper decimal fraction portion dithering block to the integer portion and to process video data.

The apparatus may include a lower decimal fraction portion mask determining block configured to receive an external control signal and determine a lower decimal fraction portion mask. The apparatus may include an upper decimal fraction portion mask determining block configured to receive the external control signal and determine an upper decimal fraction portion mask.

The apparatus may include a lower decimal fraction portion mask lookup table configured to output a mask value corresponding to the lower decimal fraction portion mask received from the lower decimal fraction portion mask determining block to the lower decimal fraction portion dithering block. The apparatus may include an upper decimal fraction portion mask lookup table configured to output a mask value corresponding to the upper decimal fraction portion mask received from the upper decimal fraction portion mask determining block to the upper decimal fraction portion dithering block.

The apparatus may include an integer portion shifter configured to shift the integer portion received from the reverse gamma correcting block and output the integer portion to the output stage block.

The lower decimal fraction portion may use a 4×4 mask. The upper decimal fraction portion may use an 8×8 mask.

Lower decimal fraction portion mask values vary by frame. The lower decimal fraction portion mask values may be generated by processing a same spatial random sequence for a plurality of frames based on a same temporal random sequence for a plurality of frames.

At least one of the above and other features and embodiments may be realized by providing a machine-readable medium that provides executable instructions, which, when executed by a processor, cause the processor to perform a method for processing video data for display on a plasma display panel using a dithering mask, the method including performing reverse gamma correction with respect to gray level values to input image signals, dividing the reverse gamma corrected gray level values into an integer portion, an upper decimal fraction portion, and a lower decimal fraction portion, dithering the lower decimal fraction, adding a first update value generated according to the lower decimal fraction dithering result to the upper decimal fraction portion, dithering the upper decimal fraction having the first update value added thereto, and adding a second update value generated according to the upper decimal fraction dithering result to the integer portion.

### BRIEF DESCRIPTION OF THE DRAWINGS

The above and other features and advantages will become more apparent to those of ordinary skill in the art by describing in detail exemplary embodiments with reference to the attached drawings, in which:

FIGS. 1A and 1B illustrate graphs comparing brightness characteristics of a general cathode ray tube (CRT) and a plasma display panel (PDP);

FIG. 2 illustrates a graph of target brightness and a result of reverse gamma correction with respect to a general low gray level region;

FIG. 3 illustrates a lower decimal fraction portion dithering mask used in a method for processing video data for display on a PDP according to an embodiment;

FIG. 4 illustrates a method making temporal and spatial masks of the lower decimal fraction portion different in a dithering process of an embodiment;

FIG. 5 illustrates an upper decimal fraction portion dithering mask in an embodiment;

FIG. 6 illustrates a dithering pattern in a moving image according to a comparative example;

FIG. 7 illustrates a dithering pattern in a moving image according to an embodiment; and

FIG. 8 illustrates a block diagram for an apparatus for processing video data according to an embodiment.

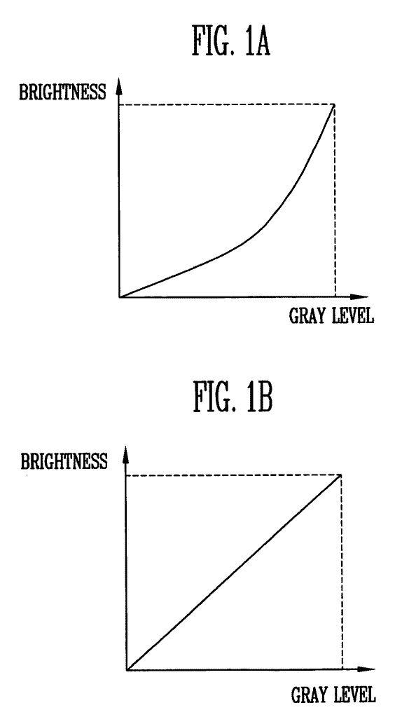

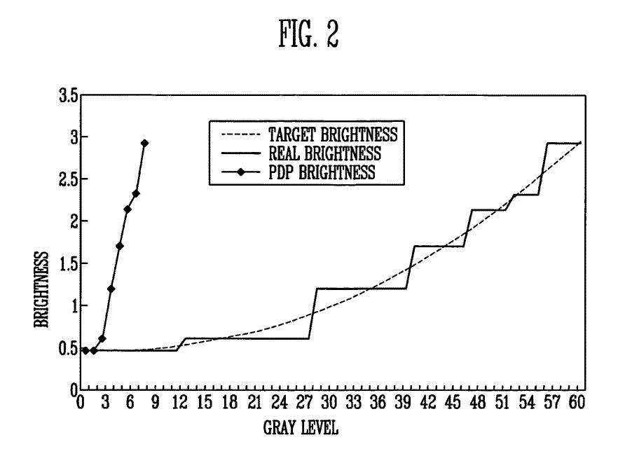

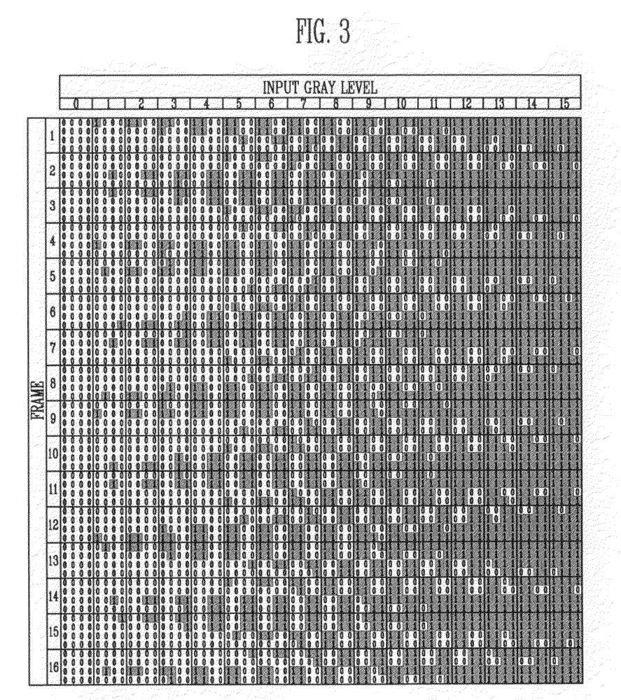

### DETAILED DESCRIPTION OF THE INVENTION

Korean Patent Application No. 10-2008-0041932, filed on May 6, 2008, in the Korean Intellectual Property Office, and entitled: “Method and Apparatus for Processing Video Data for Display on Plasma Display Panel,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the description below, a considered decimal fraction portion after reverse gamma correction is defined as 7 bits in order to increase gray level representation. Since an isolated noise and a pattern of a decimal fraction pixel mainly depends on processing of an upper decimal fraction portion, the upper decimal fraction portion uses a mask considering 4 frames in order to reduce isolated noise. As the number of considered frames increases, a difference in brightness between the decimal fraction pixel and peripheral pixels decreases. However, as the number of the considered frames increases, e.g., above four frames, an amount of flicker also increases, reducing image quality. However, an experiment verifies that flicker may be reduced by using a regular mask by one frame. Therefore, the decimal fraction pixels considering 4 frames may be adopted.

Hereinafter, a method for increasing the gray level representation and reducing the isolated noise according to a distance of the decimal fraction pixels will be described.

For reference, in order to represent 7 bits of the decimal fraction portion, a size of a dithering mask should be over 8×16. However, the when the size of the dithering mask increases, the distance of the decimal fraction pixels generated at the time of input of decimal fraction portion gray level 1 increases, and may be recognized as noise. Therefore, the method according to this embodiment may divide and process the decimal fraction portion into upper and lower decimal fraction portions.

Conventionally, when dividing the decimal fraction portion into two portions, the upper decimal fraction portion may be processed using a dithering method and the lower decimal fraction portion may be processed using an error diffusion method. An example of a suitable error diffusion method may be found in Korean Patent Publication no. 10-2005-0050773 entitled “Method and apparatus for processing gray level of display device,” which is incorporated herein by reference for all purposes.

When using the dithering method and the error diffusion method together, an error diffusion kernel should be optimized. That is, when using error diffusion, the decimal fraction pixels should be uniformly distributed and overlap of the decimal fraction pixels should be minimized. However, determination of an error diffusion kernel satisfying such a condition in a PDP that is to display various images is difficult. Therefore, the present embodiment suggests using dithering methods to process both of the upper decimal fraction portion and the lower decimal fraction portion.

The method according to the present embodiment may first perform reverse gamma correction with respect to gray level values by each of R, G, and B channels, and may divide the corrected gray level value into an integer portion, the upper decimal fraction portion, and the lower decimal fraction portion. Dithering masks temporally and spatially varying by frame may be applied to the lower decimal fraction portion in order to reduce noise due to a distance between decimal fraction pixels. Dithering masks by channel may be applied to the upper decimal fraction portion in order to reduce isolated noise, flicker, and a pattern harsh to human eyesight on the PDP.

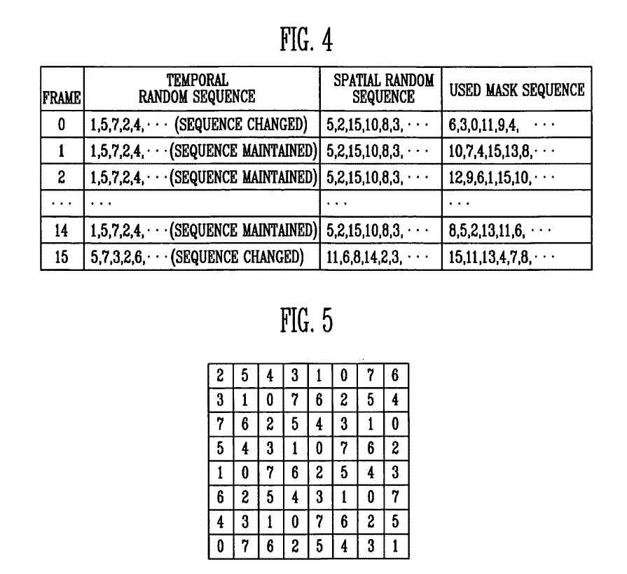

In detail, the lower decimal fraction portion may be processed as 4 bits. At this time, a 4×4 mask may be used. The 4×4 mask may be manufactured in consideration of 16 frames in order to minimize overlap of the decimal fraction pixels of the mask corresponding to gray level 1. The manufactured mask is shown in FIG. 3. FIG. 3 is a view for a lower decimal fraction portion dithering mask used in a method for processing video data for display on a PDP according to the present embodiment.

As shown in FIG. 3, the manufactured lower decimal fraction portion mask has lumped or clustered decimal fraction pixels, allowing the number of decimal fraction pixels in combination with an upper dithering mask to remain constant. By using the lower decimal fraction portion dithering method suggested in the present embodiment instead of the error diffusion method, an optimization problem of the error diffusion kernel generated at the time of the error diffusion method and an error diffusion pattern problem generated due to use of the error diffusion method may be avoided, and less memory capacity may be used.

The lower decimal fraction dithering may include a following randomization process in order to diversify combination with the upper dithering to smooth the image and reduce flicker. A frame sequence of a mask used for dithering may be updated every plurality of frames, e.g., every 16 frames, for randomization.

If an interval of frame sequence varies greatly, flicker increases. Therefore, in order to prevent this, the frame sequence of the mask may be updated only at one or both of a first part and a second part of the frame. For example, the frame sequence may be updated only between 0 frame and 8 frame and only between 9 frame and 15 frame.

An illustrative example for this is shown in FIG. 4. FIG. 4 is a view explaining a method of making temporal and spatial masks of the lower decimal fraction portion different in a dithering process of the present embodiment. For example, as illustrated in FIG. 4, 16 mask sequences may be generated by processing a spatial random sequence with a temporal random sequence along a transversal axis. After using all of the temporal random sequences, 16 mask sequences may again be updated. A spatial random sequence and a temporal random sequence may be maintained across a number of frames, e.g., 16 frames.

As noted above, a mask sequence may be generated by altering the spatial randomization based on the temporal random sequence for temporal and spatial randomization. In the particular example illustrated in FIG. 4, temporal random sequences may be determined by one set per frame. The temporal random sequence may be added transversely to the spatial random sequence to generate a used mask sequence. The temporal and spatial random sequences may be periodically changed, e.g., per sixteen (16) frames, and may be changed simultaneously. In the particular example, when the temporal random sequence is sequence of 1, 5, 7, 2, 4, etc., and the spatial random sequence is sequence of 5, 2, 15, 10, 8, 3, etc., the used mask sequence in frame 0 becomes 6, 3, 0, 11, 9, 4, etc., by adding a 0^{th} value of the temporal random sequence, here 1, to the spatial random sequence. Similarly, the used mask sequence of frame 2 becomes 12, 9, 6, 1, 15, 10, etc., by adding the 2^{nd} value of the temporal random sequence, here 7, to the spatial random sequence. All the used mask sequences for these 16 frames may be so generated.

Next, a method determining the upper decimal fraction portion dithering mask will be described, which is important in providing actual PDP image quality.

An upper decimal fraction portion dithering mask considered in the present embodiment has a 8×8 size, and may divide the decimal fraction pixels by channel and/or by frame in consideration of 4 frames. The upper decimal fraction portion dithering mask may process 3 bits. Therefore, a 2×4 mask size may be sufficient. However, an 8×8 mask may be used in consideration of differences between patterns of a still image and a moving image.

A mask value may include eight integer values: 0 to 7 at the time of 3 bit processing of the upper decimal fraction portion. While the 2×4 mask size having 8 integer values may be used, the 8×8 mask may be used in consideration of distribution of pixels according to space and time.

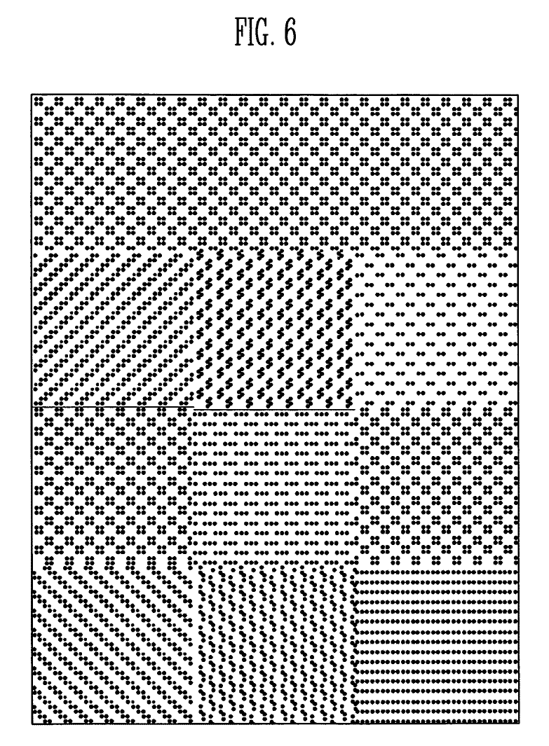

One example of the upper decimal fraction portion dithering mask for one frame, e.g., frame 1, is illustrated in FIG. 5. At this time, a dithering operation for upper decimal fraction portion may be performed by size comparison of the values. That is, when the decimal fraction value of a corresponding pixel is larger than the mask value, 1 is added to an integer least significant bit. Otherwise, 0 is added to the integer least significant bit. Likewise, masks corresponding to frames 2 to 4 may be similarly determined.

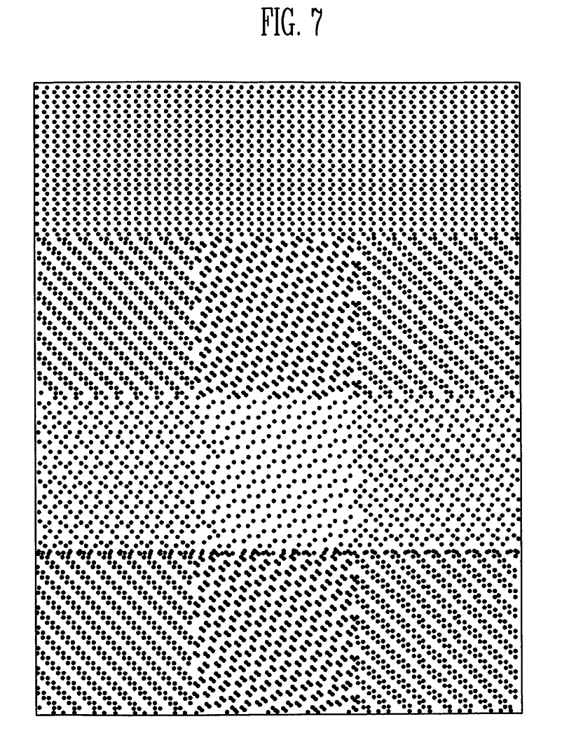

FIG. 6 illustrates a simulation image of the mask for a line pattern of a moving image generated using an existing 3 bit mask. As shown in FIG. 6, speed of the image is 0, 1, 2, and 3 from top to bottom. Speed 0 means the image is still, speed 1 means that the image moves by one pixel per one frame, and so forth.

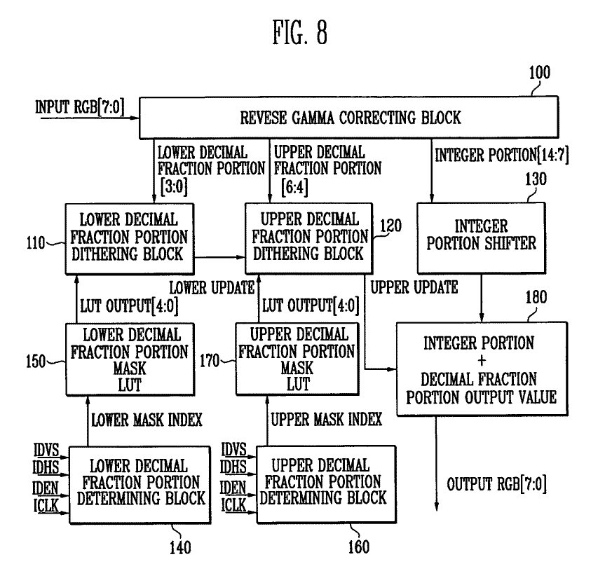

In FIG. 6, a left image is a horizontally moving image moving from right to left, a middle image is a diagonally moving image moving from right lower to left upper, and a right image is a vertically moving image moving from lower to upper. Diagonal and transversal line patterns are generated in the moving image. Also, a 2×2 check pattern may be generated in the image having speed 0, i.e. a still image, which is recognized as noise. A method reducing the noise will be described below with reference to FIG. 7.

FIG. 7 illustrates a simulation of the mask according to the present embodiment for the same speed and movements as discussed above. As shown in FIG. 7, in the mask, a transversal line pattern is not generated in images moving at speed 1 to 3. Also, a still image pattern noise may be reduced by inducing a 1×1 check pattern in the still image. A dithering pattern for different speeds may be generated by increasing mask size and/or adjusting a position of the decimal fraction pixel. This may be derived from different positions by a channel or by different patterns, and may be applied to the present embodiment.

FIG. 8 illustrates a hardware module for an apparatus for processing video data for display on a PDP according to the present embodiment. The apparatus may include a reverse gamma correcting block 100, a lower decimal fraction portion dithering block 110, an upper decimal fraction portion dithering block 120, an integer portion shifter 130, a lower decimal fraction portion mask determining block 140, a pre-prepared lower decimal fraction portion mask look up table (LUT) 150, an upper decimal fraction portion mask determining block 160, a pre-prepared upper decimal fraction mask LUT 170, and an output stage block 180

Referring to FIG. 8, the reverse gamma correcting block 100 may reverse-gamma-correct input R, G, and B values, and then may output an output value of 15 bits. The output value may be divided into an integer portion of 8 bits and a decimal fraction portion of 7 bits, wherein the decimal fraction portion may be divided and processed into an upper decimal fraction portion of 3 bits and a lower decimal fraction portion of 4 bits. The 4 bits of the lower decimal fraction portion may be input to the lower decimal fraction portion dithering block 110, the 3 bits of the upper decimal fraction portion may be input to the upper decimal fraction portion dithering block 120, and the 8 bits of the integer portion may be input to the integer portion shifter 130.

The lower decimal fraction portion mask determining block 140 may receive a frame signal IDVS, a vertical signal IDHS, a line signal IDEN, and a pixel signal ICLK, and may synchronize these signals to determine a lower decimal fraction portion mask. The determined lower decimal fraction portion mask may be input to the pre-prepared lower decimal fraction portion mask LUT 150.

The upper decimal fraction portion mask determining block 160 may receive the frame signal IDVS, the vertical signal IDHS, the line signal IDEN, and the pixel signal ICLK, and may synchronize these signals to determine an upper decimal fraction portion mask. The determined upper decimal fraction portion mask may be input to the pre-prepared upper decimal fraction mask LUT 170.

The lower decimal fraction portion mask LUT 150 and the upper decimal fraction portion mask LUT 170 may output values of the LUT, i.e., selected mask values, respectively. The selected mask values (LUT outputs) may be input to the lower decimal fraction portion dithering block 110 and the upper decimal fraction portion dithering block 120, respectively.

The lower decimal fraction portion dithering block 110 may receive the mask value from the lower decimal fraction portion mask LUT 150, and may dither the lower decimal fraction portion received from the reverse gamma correcting block 100 according to the selected mask value to output a lower decimal fraction portion update value. The output lower decimal fraction portion update value may be input to the upper decimal fraction portion dithering block 120.

The upper decimal fraction portion dithering block 120 may receive a mask value from the upper decimal fraction portion mask LUT 170, and may process the upper decimal fraction portion received from the reverse gamma correcting block 100 according to the selected mask value and the lower decimal fraction portion update value to output an upper decimal fraction portion update value. The output upper decimal fraction portion update value may be input to the output stage block 180.

The output stage block 180 may add the upper decimal fraction portion update value to the integer portion output from the integer portion shifter 130 to output a final output value (output R, G, and B) of 8 bits.

With the present embodiment, noise due to the decimal fraction pixel distance at the time of dithering processing of the PDP may be reduced, a smooth image may be displayed, and overlap of the decimal fraction pixels frames and/or channels may be reduced or prevented.

According to embodiments, noise due to the decimal fraction pixel distance generated using a general dithering method may be reduced, a smooth image may be displayed, and overlap of the decimal fraction pixels between the frames and between the channels may be reduced or prevented, in the PDP. Also, isolated noise of the decimal fraction pixels may be reduced. Additionally, flicker in the dithering considering 4 frames may be reduced by uniformly distributing the decimal fraction pixels. Finally, dithering pattern issues in both still and moving images may be reduced.

Although contents of the drawings and the detailed description as described above have disclosed optimal embodiments of the present invention, the present invention is not limited to these embodiments. While embodiments have been described relative to a hardware implementation, the processing may be implemented in software, e.g., by an article of manufacture having a machine-accessible or readable medium including data that, when accessed by a machine, e.g., a processor, cause the machine to perform a method, according to one or more aspects of the invention, for processing video data. Also, although specific terms or numerical values are used in the embodiments according to the present invention, they are not used for limiting a meaning or limiting a scope of the present invention described in claims but used for explaining the present invention. Further, it is obvious that those skilled in the art can perform various modifications and variations without departing from a scope of a technical idea of the invention. Therefore, the scope of the invention should be determined by accompanying claims, rather than the drawing or the detailed description as described above.

What is claimed is:

1. A method for processing video data for display on a plasma display panel using a dithering mask, the method comprising:
performing reverse gamma correction with respect to gray level values to input image signals;
dividing the reverse gamma corrected gray level values into an integer portion, an upper decimal fraction portion, and a lower decimal fraction portion;
dithering the lower decimal fraction;
adding a first update value generated according to the lower decimal fraction dithering result to the upper decimal fraction portion;
dithering the upper decimal fraction having the first update value added thereto; and
adding a second update value generated according to the upper decimal fraction dithering result to the integer portion.

2. The method for processing the video data for display on a plasma display panel as claimed in claim 1, wherein dithering the lower decimal fraction portion comprises updating a temporal random sequence after a prescribed number of frames.

3. The method for processing the video data for display on a plasma display panel as claimed in claim 2, wherein dithering the lower decimal fraction portion comprises updating the temporal random sequence only at one or both of a first part and a second part of a frame.

4. The method for processing the video data for display on a plasma display panel as claimed in claim 3, wherein the lower decimal fraction portion is 4 bits, the upper decimal fraction portion is 3 bits, and dithering the upper decimal fraction portion uses an 8×8 dithering mask.

5. The method for processing the video data for display on a plasma display panel as claimed in claim 2, wherein dithering the lower decimal fraction portion comprises updating a spatial random sequence after a prescribed number of frames.

6. The method for processing the video data for display on a plasma display panel as claimed in claim 5, wherein dithering the lower decimal fraction portion comprises simultaneously updating the spatial random sequence and the temporal random sequence.

7. The method for processing the video data for display on a plasma display panel as claimed in claim 5, wherein dithering the lower decimal fraction portion comprises generating a mask sequence for each frame by adding a value of the temporal random sequence for that frame to all values of the spatial random sequence.

8. The method for processing the video data for display on a plasma display panel as claimed in claim 1, wherein the input image signals are R, G, B signals.

9. The method for processing the video data for display on a plasma display panel as claimed in claim 1, further comprising, before adding the second update value, shifting the integer portion.

10. An apparatus for processing video data for display on a plasma display panel, comprising:
a reverse gamma correcting block configured to reverse gamma correct input image signals, and divide and output the reverse gamma corrected values into an integer portion, an upper decimal fraction portion, and a lower decimal fraction portion;
a lower decimal fraction portion dithering block configured to output a lower decimal fraction portion update value for the lower decimal fraction portion received from the reverse gamma correcting block;
an upper decimal fraction portion dithering block configured to add the lower decimal fraction portion update value received from the lower decimal fraction portion dithering block and to output an upper decimal fraction portion update value for the upper decimal fraction portion received from the reverse gamma correcting block; and
an output stage block configured to add the upper decimal fraction portion update value received from the upper decimal fraction portion dithering block to the integer portion and to process video data.

11. The apparatus for processing video data for display on a plasma display panel as claimed in claim 10, further comprising:
a lower decimal fraction portion mask determining block configured to receive an external control signal and determine a lower decimal fraction portion mask.

12. The apparatus for processing video data for display on a plasma display panel as claimed in claim 11, further comprising:
an upper decimal fraction portion mask determining block configured to receive the external control signal and determine an upper decimal fraction portion mask.

13. The apparatus for processing video data for display on a plasma display panel as claimed in claim 12, further comprising:
a lower decimal fraction portion mask lookup table configured to output a mask value corresponding to the lower decimal fraction portion mask received from the lower decimal fraction portion mask determining block to the lower decimal fraction portion dithering block.

14. The apparatus for processing video data for display on a plasma display panel as claimed in claim 13, further comprising:
an upper decimal fraction portion mask lookup table configured to output a mask value corresponding to the upper decimal fraction portion mask received from the upper decimal fraction portion mask determining block to the upper decimal fraction portion dithering block.

15. The apparatus for processing video data for display on a plasma display panel as claimed in claim 14, further comprising:
an integer portion shifter configured to shift the integer portion received from the reverse gamma correcting block and output the integer portion to the output stage block.

16. The apparatus for processing video data for display on a plasma display panel as claimed in claim 15, wherein the lower decimal fraction portion uses a 4×4 mask.

17. The apparatus for processing video data for display on a plasma display panel as claimed in claim 15, wherein the upper decimal fraction portion uses an 8×8 mask.

18. The apparatus for processing video data for display on a plasma display panel as claimed in claim 15, wherein lower decimal fraction portion mask values vary by frame.

19. The apparatus for processing video data for display on a plasma display panel as claimed in claim 18, wherein the lower decimal fraction portion mask values are generated by processing a same spatial random sequence for a plurality of frames based on a same temporal random sequence for a plurality of frames.

20. A machine-readable medium that provides executable instructions, which, when executed by a processor, cause the processor to perform a method for processing video data for display on a plasma display panel using a dithering mask, the method comprising:
performing reverse gamma correction with respect to gray level values to input image signals;
dividing the reverse gamma corrected gray level values into an integer portion, an upper decimal fraction portion, and a lower decimal fraction portion;
dithering the lower decimal fraction;
adding a first update value generated according to the lower decimal fraction dithering result to the upper decimal fraction portion;
dithering the upper decimal fraction having the first update value added thereto; and
adding a second update value generated according to the upper decimal fraction dithering result to the integer portion.
